(19) United States
(12) Patent Application Publication
(10) Pub. No.: US 2002/0065870 A1
(43) Pub. Date: May 30, 2002

(54) Method and apparatus for heterogeneous distributed computation

(76) Inventors: Tom Baehr-Jones, Pasadena, CA (US); Michael Hochberg, Pasadena, CA (US)

Correspondence Address: J.D. Harriman II, COUDERT BROTHERS, 333 South Hope Street, 23rd Floor, Los Angeles, CA, 90071, US

(21) Appl. No.: 09/896,533

(22) Filed: Jun. 29, 2001

Related U.S. Application Data
(60) Provisional application No. 60/215,224, filed on Jun. 30, 2000.

(51) Int. Cl. G06F 7/60

(52) U.S. Cl. 709/201; 706/922

(57) ABSTRACT

The present invention provides a method and apparatus for heterogeneous distributed computation. According to one or more embodiments, a semi-automatic process for setting up a distributed computing environment is used. Each problem that the distributed computing system must handle is described as an n-dimensional Cartesian field. The computational and memory resources needed by the computing system are mapped in a monotonic fashion to the Cartesian field.

Applicant hereby claims priority to provisional patent application Serial No. 60/215,224 filed on Jun. 30, 2000.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

1. Field of the Invention

The present invention relates to distributed computing, and in particular to a method for a solving “non-embarrassingly parallel” problems (non-EP) in a distributed memory and processing computation environment.

2. Background Art

Moore's law is an observation that the speed of computers has increased exponentially over the last thirty years or so because the density of the density of transistors on a chip doubles every eighteen months. Various techniques have been implemented to increase the speed of computers, the most prominent of which is includes the development of a faster processor (or central processing unit (CPU) with which the calculations are performed. One way of increasing the speed of a computation which is not limited by the speed of computers provided at any given time by Moore's Law is to use a parallel or distributed architecture system. Parallel processing systems are typically expensive, custom-built systems that have many processors that can all access a single memory space, so that they each can see the entire memory of the whole computer.

Another architecture is called distributed computing, which utilizes cheap, commodity PCs which are interconnected by inexpensive, commercial-grade networking hardware. The challenge with such a system is that it can be extremely difficult to program efficiently, since each processor can only see a small portion of the total memory space locally. Using the more expensive shared-memory parallel architecture reduces these problems greatly, but is extremely expensive. Both types of systems are easy to adapt for solving “embarrassingly parallel” problems. This works well with problems that are termed “embarrassingly parallel” because such problems can be solved by performing many simultaneous calculations on different sets of data, with each computation's results not affecting the outcomes of the other calculations.

For other problems, however, computations performed on one processor are highly dependant on other computations performed on other processors. In this type of problem (non-embarrassingly parallel), the processors must communicate with one another and exchange data constantly. Because the data interchange is so important, issues such as latency have the potential to completely ruin the performance of a distributed memory computer for non-EP problems, since many processors can end up being left idle, waiting for results from other processors because the network is not fast enough to transmit all of the needed data.

Moore's Law

In an attempt to predict future developments in the computer industry and by reviewing past increases in the number of transistors per silicon chip, Moore formulated what became known as Moore's law, which states that the number of transistors per silicon chip doubles each year. In 1975, as the rate of growth began to slow, Moore revised his time frame to two years. More precisely, over roughly 40 years from 1961, the number of transistors doubled approximately every 18 months. Moore's law is not exonerable, but it is merely an observation that the major approach thus far to increasing the performance of a computer is to create better and faster processors with which to operate a computer.

Limitations in Moore's Law

When computing was in its infancy, it was natural that the performance of the processor increased exponentially over time, since advances in the size of transistors and the ability to place transistors on a chip was a relatively new science. The reason that Moore's law has proved difficult to keep pace with into the future relates to inherent problems in the approach computer makers have taken.

Namely, the approach to keeping pace with Moore's law has been to continue to attempt to produce more powerful processors, for instance by advancing transistor technology and further miniaturizing the components so that more will fit into a smaller space. As the technology continues to advance the ability to even make small advances becomes ever increasingly difficult. It is likely that Moore's Law will break down in the near future either because of fundamental physical limitations associated with a CMOS process or because of economic limitations. It would be desirable to have a way to massively speed up using currently available hardware, especially in light of the possible failure of Moore's Law.

Massively Parallel Approaches

One different approach to continuing to increase the speed of the processor is to use several (or a massive number) of parallel processors connected together in a distributed computing environment. In such an environment, several processors are used in a computing system and each one is able to perform an instruction in each clock cycle. Theoretically, it is possible to achieve a faster system in this manner because even if the one or more processors in the distributed environment are less powerful than a single processor, they can outperform it because they each act in parallel.

For embarrassingly parallel problems, this solution is powerful. Embarrassingly parallel problems are fine grained. This means that the problem can be broken down into many very small pieces. Each piece never has to communicate with the other pieces to produce a solution. For instance, when looking for large prime numbers, what might be done is to take three computers and assign a number range to each computer. Thus, computer 1 night search for primes between 1 million and 2 million, while computer 2 would search for primes between 2 million and 3 million, and so on.

Non-Embarrassingly Parallel Problems

Certain problems, by their very nature, are not embarrassingly parallel. One example of such a problem is called a finite difference time domain (FDTD), which is an electrodynamic simulation. The FDTD algorithm can be used to simulate the evolution of Maxwell's equations in time. On a single processor architecture, the core FDTD algorithm consists of a matrix of electromagnetic field components. Each component has a linear dependence on directly neighboring components. Evolving the field in time, and thus performing the computation, consists of applying this linear relation repeatedly.

Both parallel and distributed implementations of FDTD are based on assigning subspaces of the entire FDTD grid to individual processors. In both cases, applying the linear relation at the border of a given subspace requires information that exists in a different subspace. To perform such a simulation requires heavy communication between the processors and data frequently needs to be exchanged between the processors. For instance, if processor A depends on the result of a computation the processor B is currently making, then processor A must wait until processor B is finished and sends the result to it. Such a simulation is essentially one huge computation spread across multiple machines.

Problems occur in distributed computing when tackling problems that are not embarrassingly parallel, such as FDTD. Namely, a significant time penalty is introduced. For instance, a cluster of PCs connected by Ethernet, has a network bandwidth and latency that is often 100 times slower than memory bank access. The fact that computational data is no longer directly available to all of the processors has significant ramifications for algorithm design.

This means that two processors acting in parallel do not perform as fast as a single processor that has twice the computing speed as the parallel processors. Latency is introduced, in part because data constantly needs to be exchanged between the multiple processors. If processor A depends on the result of a computation the processor B is currently making, then processor A must wait until processor B is finished and sends the result to it. Situations like this where latency is large tend to reduce the efficiency of a distributed computing environment.

Moreover, the heavy exchange of data between multiple processors demands a large amount of available memory to store the data. An electrodynamic simulation, for instance, typically requires tens of thousands of gigabytes of available memory. Thus setting up and managing of a distributed computing environment is difficult, expensive, time consuming, and complex for non-embarrassingly parallel problems; writing efficient, distributed code is extremely difficult, partially because of a lack of integrated tools or an environment for writing distributed code.

### SUMMARY OF THE INVENTION

The present invention provides a method and apparatus for heterogeneous distributed computation. According to one or more embodiments, a semi-automatic process for setting up a distributed computing environment is used. Each problem that the distributed computing system must handle is described as an n-dimensional Cartesian field. The computational and memory resources needed by the computing system are mapped in a monotonic fashion to a Cartesian field.

In one embodiment, a domain decomposition is performed where an n-dimensional space is partitioned between machines. Each machine communicates with the others. In one embodiment, a special sub-class of the domain decomposition is chosen having the property that it is simple to load balance. In one embodiment, the distributed computing environment comprises a master and multiple slaves. The master is responsible for load balancing and control code. The slaves are responsible for the actual computations and storing the computation data.

In one embodiment, the domain of slaves is divided by the master by splitting it into a binary tree and the domains are dynamically sub-divided by a recursive process, which attempts to keep all processors in a shared memory space in the same sub-group until a subgroup consists of only processors in a shared memory space. The recursion continues until each group has only one processor. As computations proceed the regions change in the time required to complete their tasks. Periodically, the regions are load balanced so that each region will end its calculations at a similar time. In one embodiment, this is achieved by load balancing the binary tree.

### BRIEF DESCRIPTION OF THE DRAWINGS

These and other features, aspects and advantages of the present invention will become better understood with regard to the following description, appended claims and accompanying drawings where:

FIG. 1 provides a master-slave configuration according to an embodiment of the present invention.

FIG. 2 shows heterogeneous distributed computation according to an embodiment of the present invention.

FIG. 3 shows heterogeneous distributed computation according to an embodiment of the present invention.

FIG. 4 shows heterogeneous distributed computation utilizing shared memory space according to an embodiment of the present invention.

FIG. 5 shows heterogeneous distributed computation using a binary tree according to an embodiment of the present invention.

FIG. 6 shows haw a two-dimensional computation domain might be partitioned by an embodiment of the present invention.

FIG. 7 shows dynamic load balancing according to an embodiment of the present invention.

FIG. 8 shows an embodiment of a computer execution environment.

FIG. 9 shows domain partitioning according to an embodiment of the present invention.

### DETAILED DESCRIPTION OF THE INVENTION

The invention is a method and apparatus for heterogeneous distributed computation. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Master and Slave Nodes

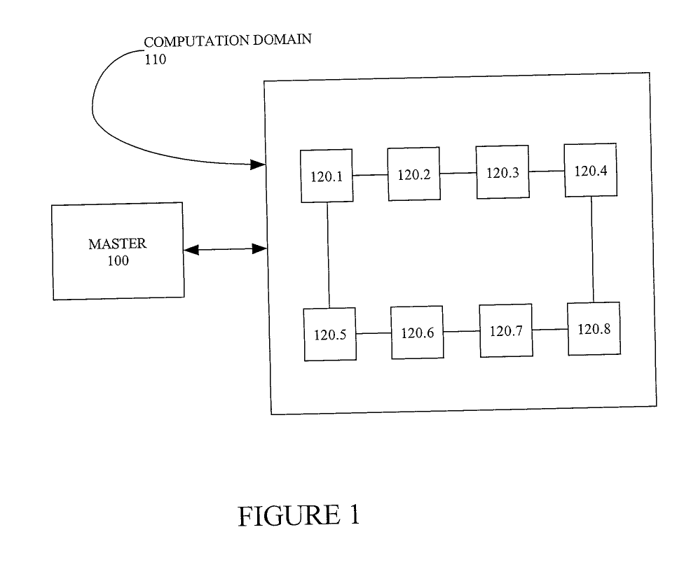

According to one embodiment of the present invention, multiple computers are connected. One computer is designated as the master, the rest are designated as slaves. All control code and load balancing is performed by the master. All of the computations and storing of the computation data is performed by the slaves. FIG. 1 provides one example of a master slave configuration. Master 100 is connected to computation domain 110 and executes control code and balances load in the computation domain 110. Computation domain 110 comprises computers 120.1-120.8. Computers 120.1-120.8 are connected to one another and the master 100 via a computer network Computers 120.1-120.8 may use shared memory or some sub-groups of computers 120.1-120.8 may have shared memory.

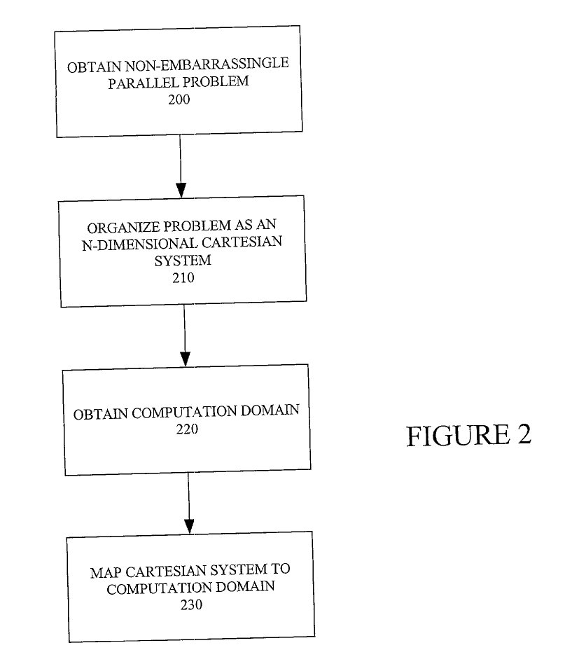

FIG. 2 shows one embodiment of the present invention. At step 200 a non-embarrassingly parallel problem is obtained. At step 210, the problem is organized in an n-dimensional Cartesian system. At step 220, a computation domain comprising multiple parallel computers is obtained. At step 230, the Cartesian system is mapped to the computation domain by dividing the domain into sub-domains.

The general structure of problems solved by the present invention are as follows:

1. The problem can be described as an n-dimensional Cartesian field;

2. That the computational and memory resources can be mapped in some monotonic fashion to this field;

3. That an algorithm can be designed such that the computation associated with arbitrary sub dimensions of the field can go forward with access to minimal portions of the memory associated with other field fragments; and

4. That the algorithm can then be implemented as a number of steps to be performed in lockstep over the cluster.

Consider the parallelization of a generalized finite element algorithm, such as might be used to model elastic strain on a material. Such an algorithm might have a number of points positioned arbitrarily in a non-Cartesian volume in, for instance, three dimensions. The field setup would then be able to define the field in some Cartesian grid to be a collection of the point coordinates of the points located inside this sub-domain. Since the points do not have a uniform density, there is not a linear correspondence between the amount of memory usage (or computation time). However, there is a monotonic relationship. In other words, if a fragment of the field is made larger, memory usage does not decrease. The same argument holds for the computation usage of the problem.

So, conditions 1 and 2 require that the structure of the memory associated with the problem be amicable to some sort of partitioning. This does not require a Cartesian field, just some sort of data structure that can organize itself into monotonic spatial regions. Conditions 1 and 2 also require that the computational work associated with these parts of the problem be breakable in a monotonic fashion.

Condition 3 states that the algorithm can be performed separately and simultaneously on the different nodes. The nodes may require periodic updating of boundaries between steps of a computation. The ratio of the amount of memory that must be transferred to the amount of computation that must be executed is the ultimate determining factor in whether or not a computation may be efficiently distributed. In many cases there will asymptotically be 1/n, which means efficient parallelization for most problems, given modern network speeds.

Condition 4 implies that there is a sequence of finite steps that, when repeated, perform the work of the algorithm. For instance, in some sort of linear solver, there might be a matrix multiplication phase, followed by a vector subtraction phase, etc.

Implementation

In one embodiment, the scheme is organized as follows:

User application→Parallelization library→Communication layer/Virtual Machine

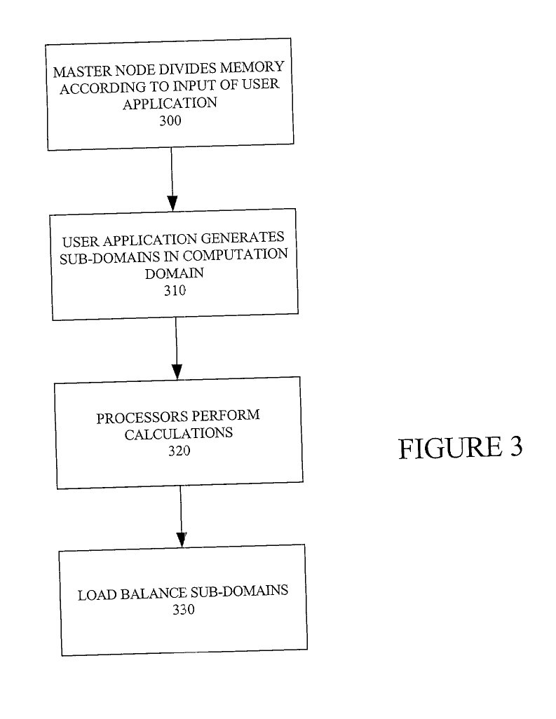

The master node first divides memory according to the input of the user application. This is performed by generating an “n-box”. An n-box is a generic n-dimensional Cartesian system. It is assumed that there is a single n-box that defines the domain of the computation. The user application generates fragments which are distinct sub-domains of the n-box. FIG. 3 shows this embodiment of the present invention.

First, the master node first divides memory according to the input of the user application at step 300 (i.e., it generates an “n-box”). At step 310 The user application generates fragments which are distinct sub-domains of the n-box. At step 320, the processors perform calculations. At step 330, the sub-domains are load balanced. In one embodiment, the sub-domains have specific characteristics that specify the routines to be run for time stepping, or generally any sequential, distributed execution of an algorithm. In another embodiment, the routines specify the allocation, serialization, and repartitioning routines that enable a parallelization engine to shuffle the fragments around transparently on the system of slave nodes. In another embodiment, the routines specify the estimated amount of memory, and the number of flops required for computation.

Shared Memory Space

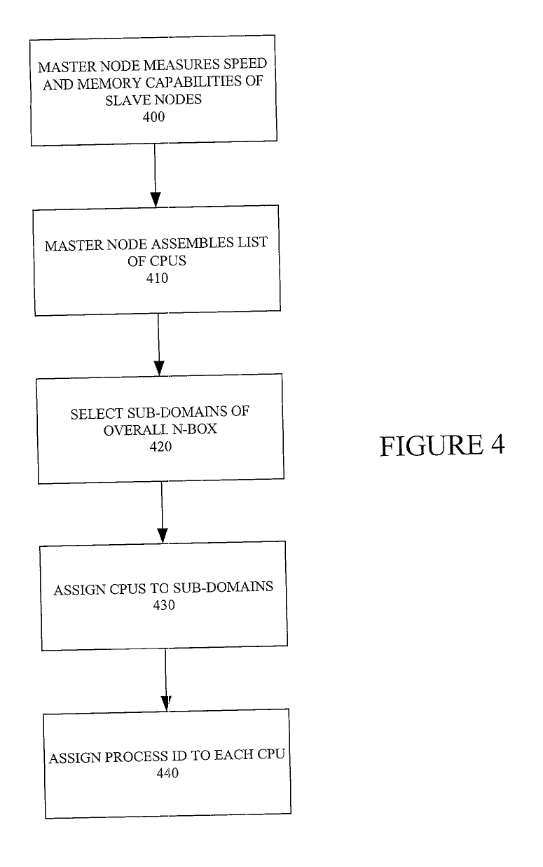

One embodiment of the present invention partitions sub-domains by placing computers having shared memory space in the same sub-domain, if possible. this embodiment is shown in FIG. 4. First, the master node measures the speed and memory capabilities of all of the slave nodes at step 400. Such values may be stored in a configuration file, for example. The master node assembles a list of processors at step 410, which may or may not be in the same shared memory space. At step 420 the computation is distributed by selecting various sub-domains of an overall n-box (i.e., the computation domain). Then, a processor is assigned to every sub-domain at step 430. Each processor receives a unique process id to facilitate communication at step 440.

Binary Tree

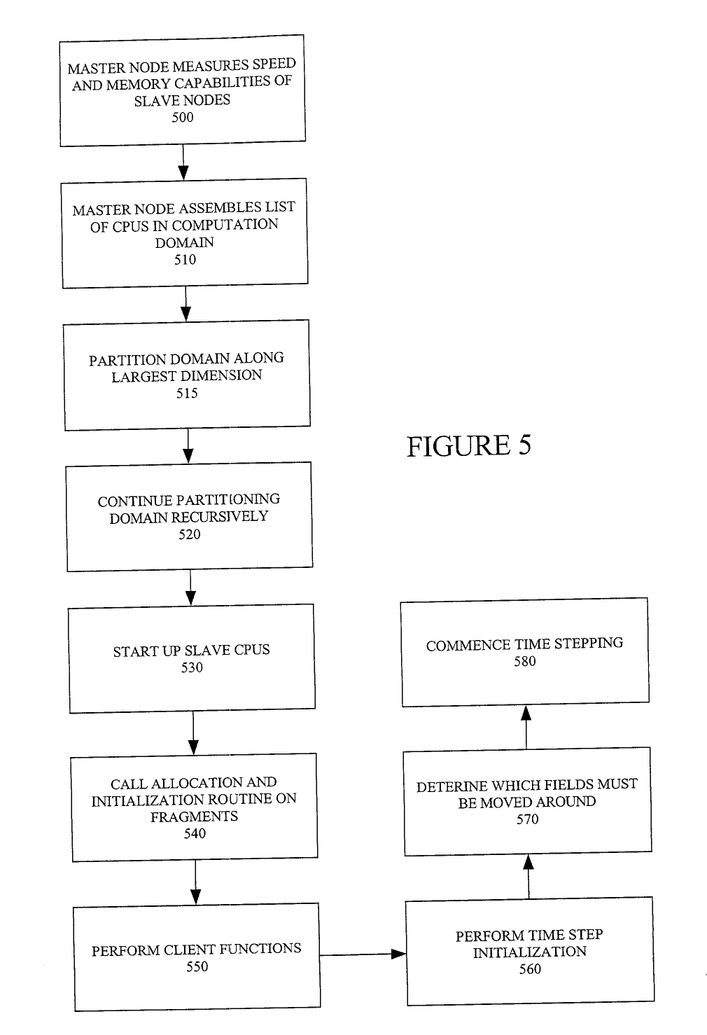

One manner in which the sub-domains maybe partitioned is using a binary tree. This embodiment is shown in FIG. 5. First, the master node measures the speed and memory capabilities of all of the slave nodes at step 500. At step 510, the master node assembles a list of processors in the computation domain. Next, at step 515, space is partitioned along the largest dimension of the domain, and half the processors are assigned to one side of the binary tree and half to another.

In one embodiment of the present invention, the binary tree attempts to do achieve as equal a splitting in flops as possible, constrained by the condition that the required memory on each side be met by the combined available memory of each group of processors. Processors in the same shared memory space are not split from each other until a group consists of only processors with shared memory. This measure attempts to ensure that processors in a shared memory environment, and therefore faster communication, are next to each other, thus reducing the network bandwidth needed.

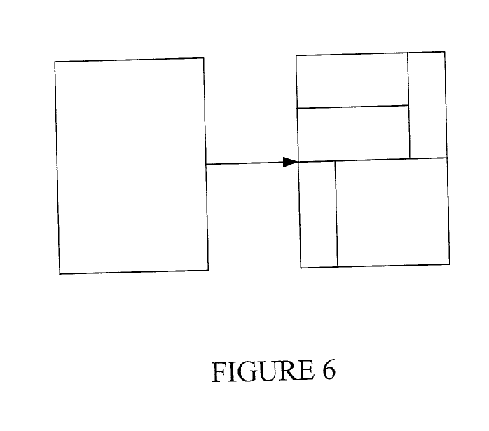

This partitioning is performed recursively at step 520, until every group of processors consists of one processor. A two-dimensional domain, then, might be partitioned for 5 (unequal) processors as shown in FIG. 6. Now, the salve cups are started up at step 530, either using a virtual machine interface such as PVM, or another communications protocol capable of this. The allocation and initialization routines are called on all fragments at step 540. At any point after this, client functions such as structure fabrication, or random access to field components, can occur at step 550. Such requests typically start at the user application, access the parallelization library, which then processes the request and breaks it up to send it to each of the clients.

The next step in a computation is time step initialization at step 560. In this step, each fragment deduces what data it will need at which distinct time step phases and relates these needs to the engine. The engine then processes these queries and determines which types of fields must be moved around at different time step points at step 570. Time stepping then commences at step 580; with every distinct time step in the sequence, there is a computational task that the fragments all perform. At the same time, the engine moves the appropriate field regions around the slave nodes.

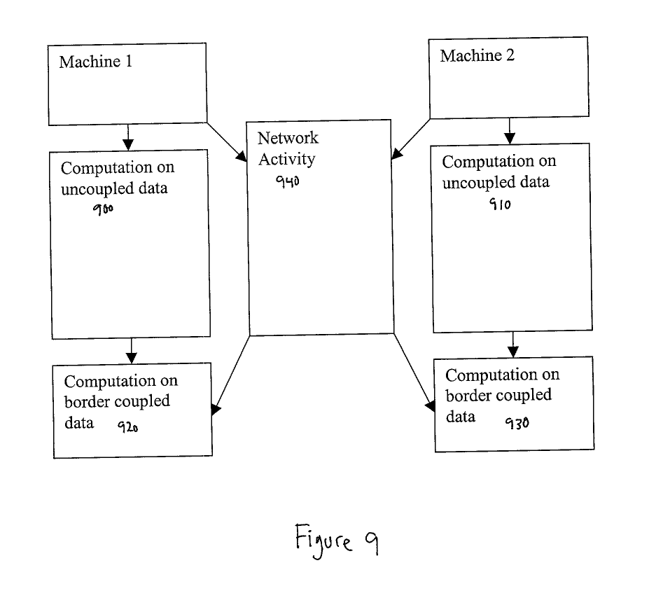

The manner in which one embodiment of the present invention moves the appropriate fields around the slave nodes is shown in FIG. 9. There are 2 distinct phases of computation, and one phase of network activity. For a given phase of the computation, there is a set of work that can be done without access to the data located on other nodes in blocks 900 and 910. While this step is occurring on the each node, the engine is moving the needed data from node to node. There is another computation step that then occurs, the computation that depends on data from other machines in blocks 920 and 930.

It is precisely this sequence that determines the scaling of the computation. If the network activity 940 does not take as long as the uncoupled computation activity, then provided there is proper flop based balancing, perfect linear scaling can be expected. If, however, the network activity 940 takes longer than the uncoupled computation activity 900 and 910, then linear scaling can't be obtained. In the case of FDTD, the network activity time length is proportional to nˆ 2, while the computational activity is proportional to nˆ 3, where n is the length of a side of the computation. Thus, for FDTD, linear scaling can be achieved by embodiments of the present invention.

Dynamic Load Balancing

In one embodiment, the fragments accurately described their flop requirements, and the cluster is properly load balanced initially. However, computation requirements for distinct regions may change over time; for instance, one might implement adaptive meshing for a simulation, which would increase the grid density, and therefore the processor requirements, for a given region. In this scenario, it is useful to perform dynamic load balancing to ensure that the calculations take place as efficiently as possible.

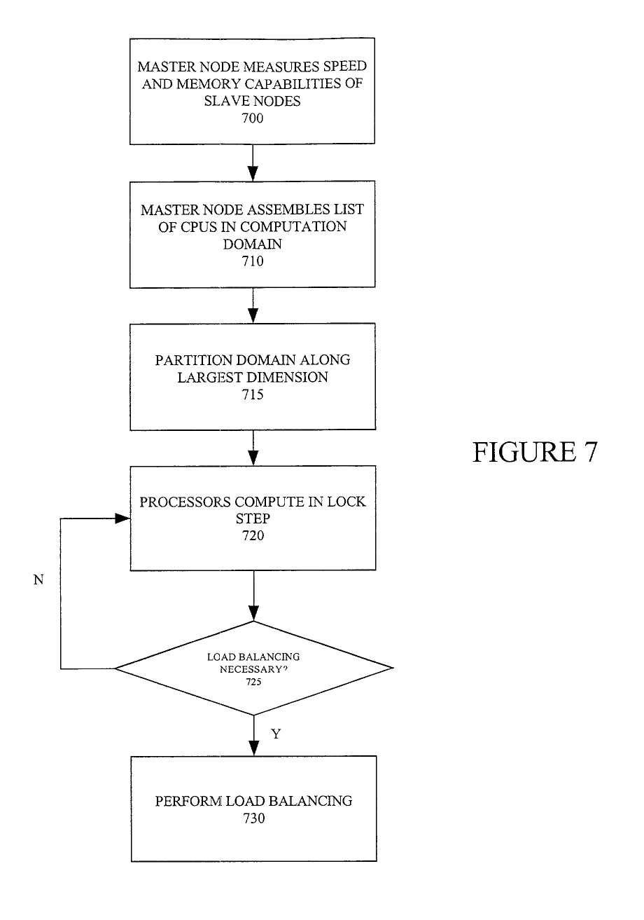

One manner in which one embodiment performs dynamic load balancing is shown in FIG. 7. First, the master node measures the speed and memory capabilities of all of the slave nodes at step 700. At step 710, the master node assembles a list of processors in the computation domain. Next, at step 715, space is partitioned along the largest dimension of the domain, and half the processors are assigned to one side of the binary tree and half to another.

Next, the processors compute in lock step at step 720. At step 725, it is determined if load balancing is necessary. If not, step 720 repeats. Otherwise, different levels of the binary tree are load balanced to successively to insure that the ratio of the number of flops required per time step to the number of flops available flops in a processor group is equal. This would theoretically insure perfect balancing.

In practice, predicting the exact location of the computationally intensive regions is difficult, and thus it is best to implement this load balancing as some sort of iterative scheme on each level, akin to a binary insertion. Since the number of nodes supported in a binary tree grows exponentially, aside from the load on the master at each level, there is not a large performance penalty for this kind of balancing.

Embodiment of Computer Execution Environment (Hardware)

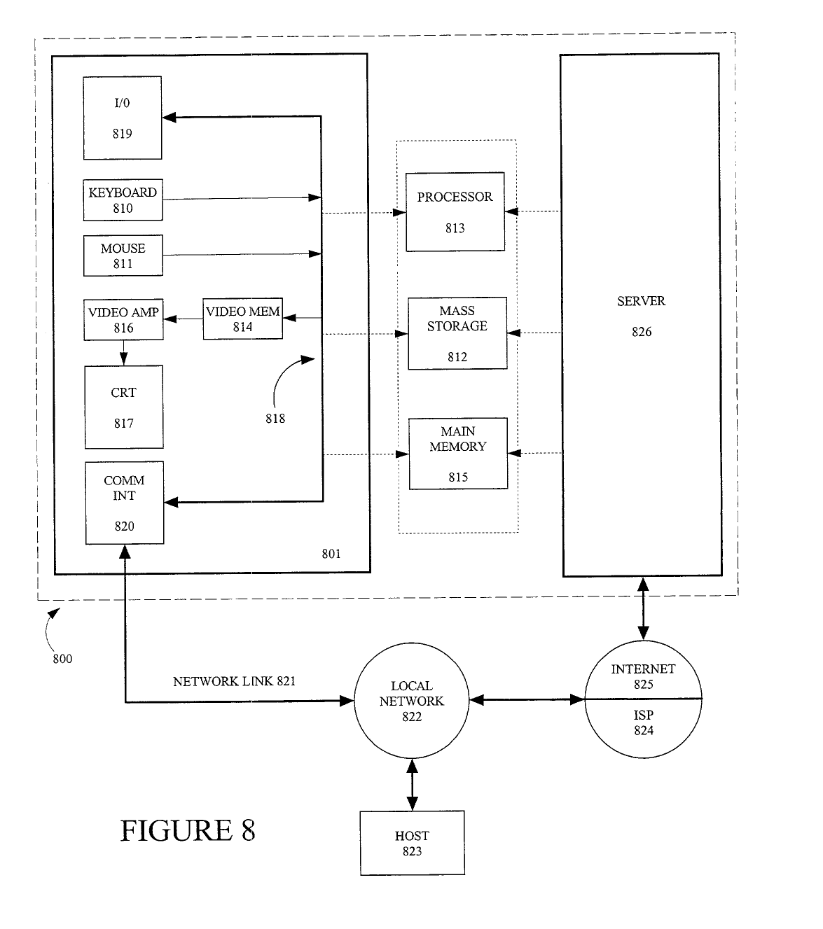

An embodiment of the invention can be implemented as computer software in the form of computer readable program code executed in a general purpose computing environment such as environment 800 illustrated in FIG. 8, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 810 and mouse 811 are coupled to a system bus 818. The keyboard and mouse are for introducing user input to the computer system and communicating that user input to central processing unit (CPU) 813. Other suitable input devices may be used in addition to, or in place of, the mouse 811 and keyboard 810. I/O (input/output) unit 819 coupled to bi-directional system bus 818 represents such I/O elements as a printer, A/V (audio/video) I/O, etc.

Computer 801 may include a communication interface 820 coupled to bus 818. Communication interface 820 provides a two-way data communication coupling via a network link 821 to a local network 822. For example, if communication interface 820 is an integrated services digital network (ISDN) card or a modem, communication interface 820 provides a data communication connection to the corresponding type of telephone line, which comprises part of network link 821. If communication interface 820 is a local area network (LAN) card, communication interface 820 provides a data communication connection via network link 821 to a compatible LAN. Wireless links are also possible. In any such implementation, communication interface 820 sends and receives electrical, electromagnetic or optical signals which carry digital data streams representing various types of information.

Network link 821 typically provides data communication through one or more networks to other data devices. For example, network link 821 may provide a connection through local network 822 to local server computer 823 or to data equipment operated by ISP 824. ISP 824 in turn provides data communication services through the world wide packet data communication network now commonly referred to as the “Internet” 825. Local network 822 and Internet 825 both use electrical, electromagnetic or optical signals which carry digital data streams. The signals through the various networks and the signals on network link 821 and through communication interface 820, which carry the digital data to and from computer 800, are exemplary forms of carrier waves transporting the information.

Processor 813 may reside wholly on client computer 801 or wholly on server 826 or processor 813 may have its computational power distributed between computer 801 and server 826. Server 826 symbolically is represented in FIG. 8 as one unit, but server 826 can also be distributed between multiple “tiers”. In one embodiment, server 826 comprises a middle and back tier where application logic executes in the middle tier and persistent data is obtained in the back tier. In the case where processor 813 resides wholly on server 826, the results of the computations performed by processor 813 are transmitted to computer 801 via Internet 825, Internet Service Provider (ISP) 824, local network 822 and communication interface 820. In this way, computer 801 is able to display the results of the computation to a user in the form of output.

Computer 801 includes a video memory 814, main memory 815 and mass storage 812, all coupled to bi-directional system bus 818 along with keyboard 810, mouse 811 and processor 813.

As with processor 813, in various computing environments, main memory 815 and mass storage 812, can reside wholly on server 826 or computer 801, or they may be distributed between the two. Examples of systems where processor 813, main memory 815, and mass storage 812 are distributed between computer 801 and server 826 include the thin-client computing architecture developed by Sun Microsystems, Inc., the palm pilot computing device and other personal digital assistants, Internet ready cellular phones and other Internet computing devices, and in platform independent computing environments, such as those which utilize the Java technologies also developed by Sun Mcrosystems, Inc.

The mass storage 812 may include both fixed and removable media, such as magnetic, optical or magnetic optical storage systems or any other available mass storage technology. Bus 818 may contain, for example, thirty-two address lines for addressing video memory 814 or main memory 815. The system bus 818 also includes, for example, a 32-bit data bus for transferring data between and among the components, such as processor 813, main memory 815, video memory 814 and mass storage 812. Alternatively, multiplex data/address lines may be used instead of separate data and address lines.

In one embodiment of the invention, the processor 813 is a microprocessor manufactured by Motorola, such as the 680X0 processor or a microprocessor manufactured by Intel, such as the 80X86, or Pentium processor, or a SPARC microprocessor from Sun Microsystems, Inc. However, any other suitable microprocessor or microcomputer may be utilized. Main memory 815 is comprised of dynamic random access memory (DRAM). Video memory 814 is a dual-ported video random access memory. One port of the video memory 814 is coupled to video amplifier 816. The video amplifier 816 is used to drive the cathode ray tube (CRT) raster monitor 817. Video amplifier 816 is well known in the art and may be implemented by any suitable apparatus. This circuitry converts pixel data stored in video memory 814 to a raster signal suitable for use by monitor 817. Monitor 817 is a type of monitor suitable for displaying graphic images.

Computer 801 can send messages and receive data, including program code, through the network(s), network link 821, and communication interface 820. In the Internet example, remote server computer 826 might transmit a requested code for an application program through Internet 825, ISP 824, local network 822 and communication interface 820. The received code maybe executed by processor 813 as it is received, and/or stored in mass storage 812, or other non-volatile storage for later execution. In this manner, computer 800 may obtain application code in the form of a carrier wave. Alternatively, remote server computer 826 may execute applications using processor 813, and utilize mass storage 812, and/or video memory 815. The results of the execution at server 826 are then transmitted through Internet 825, ISP 824, local network 822 and communication interface 820. In this example, computer 801 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a method and apparatus for heterogeneous distributed computation is described in conjunction with one or more specific embodiments. The invention is defined by the claims and their full scope of equivalents.

1. A method for a distributed computation comprising:
defining a problem as a Cartesian grid;
obtaining a computation domain comprising one or more parallel processors;
mapping said Cartesian grid to said computation domain.

2. The method of claim 1 wherein said step of mapping further comprises:
sub-dividing said computation domain.

3. The method of claim 2 wherein said step of sub-dividing further comprises:
defining said computation domain as a binary tree; and
dividing said binary tree.

4. The method of claim 3 wherein said step of dividing further comprises:
recursively dividing said computation domain into one or more sub-domains wherein one or more processors having a shared memory remain in a common sub-domain.

5. The method of claim 1 wherein said processors are slaves and said step of mapping is performed by a master.

6. The method of claim 1 wherein said problem is a non-embarrassingly parallel problem.

7. The method of claim 3 further comprising:
dynamically load balancing said computation domain, if necessary.

8. The method of claim 7 wherein said step of dynamically load balancing further comprises:
performing a binary insertion operation into said binary tree.

9. An apparatus comprising:
a problem configured to be defined as a Cartesian grid;
a computation domain comprising one or more parallel processors configured to be obtained;
a master configured to map said Cartesian grid to said computation domain.

10. The apparatus of claim 9 wherein said master further comprises:
a divider configured to sub-divide said computation domain.

11. The apparatus of claim 10 wherein said divider further comprises:
a binary tree configured to define said computation domain; and
a second divider configured to divide said binary tree.

12. The apparatus of claim 11 wherein said second divider further comprises:
a recursive function configured to recursively divide said computation domain into one or more sub-domains wherein one or more processors having a shared memory remain in a common sub-domain.

13. The apparatus of claim 9 wherein said processors are slaves and said master is a computer.

14. The apparatus of claim 9 wherein said problem is a non-embarrassingly parallel problem.

15. The apparatus of claim 12 further comprising:
a dynamic load balancer configured to dynamically load balancing said computation domain, if necessary.

16. The apparatus of claim 15 wherein said dynamic load balancer further comprises:
a binary inserter configured to perform a binary insertion operation on said binary tree.

17. A computer program product comprising:
a computer usable medium having computer readable program code embodied therein configured to distribute a computation, said computer program product comprising:
computer readable code configured to cause a computer to define a problem as a Cartesian grid;
computer readable code configured to cause a computer to obtain a computation domain comprising one or more parallel processors;
computer readable code configured to cause a computer to map said Cartesian grid to said computation domain.

18. The computer program product of claim 18 wherein said step of mapping further comprises:
computer readable code configured to cause a computer to sub-divide said computation domain.

19. The computer program product of claim 17 wherein said computer readable code configured to cause a computer to sub-divide further comprises:
computer readable code configured to cause a computer to define said computation domain as a binary tree; and
computer readable code configured to cause a computer to divide said binary tree.

20. The computer program product of claim 19 wherein said computer readable code configured to cause a computer to divide further comprises:
computer readable code configured to cause a computer to recursively divide said computation domain into one or more sub-domains wherein one or more processors having a shared memory remain in a common sub-domain.

21. The computer program product of claim 17 wherein said processors are slaves and said computer readable code configured to cause a computer to map is performed by a master.

22. The computer program product of claim 17 wherein said problem is a non-embarrassingly parallel problem.

23. The computer program product of claim 19 further comprising:
computer readable code configured to cause a computer to dynamically load balance said computation domain, if necessary.

24. The computer program product of claim 23 wherein said computer readable code configured to cause a computer to dynamically load balance further comprises:
computer readable code configured to cause a computer to perform a binary insertion operation into said binary tree.
